(19) United States
(12) Patent Application Publication
(10) Pub. No.: US 2024/0409814 A1
(43) Pub. Date: Dec. 12, 2024

(54) Methods For Producing Biodegradable Mulch Material And Materials Produced Therefrom

(71) Applicant: Russell LaFazia, Cranston, RI (US)

(72) Inventor: Russell LaFazia, Cranston, RI (US)

(21) Appl. No.: 18/737,663

(22) Filed: Jun. 7, 2024

Related U.S. Application Data
(60) Provisional application No. 63/471,534, filed on Jun. 7, 2023.

(51) Int. Cl. C09K 17/52; A01G 13/02; C05C 11/00; C05F 9/04; C09K 101/00

(52) U.S. Cl. CPC C09K 17/52; A01G 13/0262; C05C 11/00; C05F 9/04; C09K 2101/00

(57) ABSTRACT

The present invention provides a new mulch material that can control weed growth and enhance the fertility and richness of the underlying soil. The mulch material of the invention can decompose and be absorbed into the underlying soil over time. The present invention also provides a method for making such biodegradable mulch material. In one preferred embodiment, the biodegradable mulch comprises biodegradable newsprint and/or newspaper. leaves, and coffee grounds.

### CROSS-REFERENCE TO RELATED APPLICATIONS

The application claims the benefit of U.S. Provisional Patent Application No. 63/471,534 filed Jun. 7, 2023, the entire disclosure of which is hereby incorporated by reference.

### BACKGROUND OF THE INVENTION

### Field of the Invention

The present invention relates generally to methods for producing biodegradable weed-blocking and soil-enhancing mulch and the mulch material produced from such methods.

### Background of the Invention

In recent years, more people have become interested in using various products for controlling weed growth in flower and vegetable gardens, and around trees, hedges, shrubbery, and the like. For example, black-colored weed control mats, which are made of polypropylene, are commonly used. Recycled rubber mats are also used. Normally, the weed control mat is placed above the soil to prevent the germination and growth of weeds. In general, such weed control mats work by allowing air and water through the fabric to retain moisture, but the fabrics prevent sunlight from passing through. Some weed control mats can be generally effective in controlling weed growth. However, one problem with such weed control mats is they are not biodegradable.

Another commonly used product for controlling weed growth is organic-based mulch. There are various materials that can be used as mulch including, for example, vegetation such as grass clippings, leaves, hay, straw, bark, woodchips, and compost. Such mulch products have good weed-blocking properties and additional benefits such as, for example, retaining soil moisture and enhancing soil fertility. However, there are some drawbacks with using conventional mulch products including their cost and handling. For example, it can be difficult and expensive to transport conventional mulch products to a work site. Also, applying such mulch products to cover the soil in a vegetable or flower garden or other site can be labor-intensive and time-consuming. Some lawn and garden centers sell mulch products that are pre-packaged in bags for carry-out. However, such mulch bags also can be expensive, and it can be time-consuming to purchase, transport and apply such mulch materials.

There is a need for a new mulch material that is able to control weed growth and enhance the fertility and richness of the underlying soil. The mulch material should decompose and absorb into the underlying soil over time. The method for producing such mulch material should be efficient at a relatively low cost, and the mulch should be easy to apply over the soil in a flower or vegetable garden or other work site. The present invention provides methods for making such biodegradable mulch material and the resulting mulch. The mulch material and methods of the invention have other advantages, features, and benefits as described further below.

### SUMMARY OF THE INVENTION

The present invention provides methods for making biodegradable mulch material. The mulch material is able to control weed growth and enhance the fertility and richness of the underlying soil. The mulch material decomposes and absorbs into the underlying soil over time. The methods for producing the mulch material of the present invention are efficient and economically advantageous. The biodegradable mulch material is easy to apply over the soil in a flower or vegetable garden or other work site.

In one preferred embodiment, the method comprises the steps of: a) soaking newspaper in a relatively warm or hot water bath; b) allowing the newspaper to soak in the water bath for a sufficient period time to soften the paper; c) pounding the newspaper so that it breaks down and forms a paper pulp; d) adding organic matter to the paper pulp; and e) pouring the paper pulp onto a screen and spreading the pulp evenly so that it covers the screen. Preferably, the water bath has a temperature in the range of about 110° F. to about 130° F.; and the newspaper is allowed to soak in the water bath for a time period in the range of about five (5) to about ten (10) minutes. The present invention also encompasses a biodegradable mulch material made according to the above-described methods.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a perspective view of a biodegradable mulch sheet made in accordance with the present invention;

FIG. 2 is a perspective view of a second example of biodegradable mulch material made in accordance with the present invention;

FIG. 3 is a perspective view of a first example of a flower garden bed showing the biodegradable mulch material of FIG. 2 spread over the garden bed;

FIG. 4 is a perspective view of a second example of a flower garden bed showing the biodegradable mulch material of FIG. 2 spread over the garden bed; and

FIG. 5 is a perspective view of a third example of a flower garden bed showing the biodegradable mulch material of FIG. 2 spread over the garden bed.

### DETAILED DESCRIPTION OF THE INVENTION

The present invention relates generally to methods for producing biodegradable weed-blocking and soil-enhancing mulch and mulch materials produced from such methods. The biodegradable mulch of the present invention can provide a barrier to growing weeds and enriches the soil as it decomposes over time.

As used herein, the term “biodegradable” means the breakdown of the material or component thereof by microorganisms such as fungi or bacteria. The biodegradable mulch of this invention comprises biodegradable newsprint and/or newspaper. By the term, “newsprint” it means paper comprising mainly wood pulp and used to print newspapers. By the term, “newspaper”, it means newsprint that is printed with ink or toner or other suitable material. The newspapers can be printed with any printing process including, but not limited to, offset printing press and digital printing. In traditional processes for manufacturing newsprint, wood, particularly softwood such as spruce, fir, and pine, is debarked and cut into small pieces and later chipped to make wood chips. The wood chips are processed into wood pulp. This process involves treating the wood chips with steam to soften them up. This makes it easier for the wood chips to be processed into wood pulp.

In general, there are three main grades of newsprint: i) standard newsprint; ii) improved newsprint; and iii) specialty newsprint. These grades of newsprint have different properties such as thickness, brightness, mechanical strength, ink absorption capabilities, and texture. Any suitable newsprint grade can be used in accordance with the present invention. In general, newsprint comprises cellulose and hemicellulose (natural wood fibers) and lignin, which is a substance that helps bind cellulose fibers. Lignin also occurs naturally in wood. In addition to wood pulp, vegetable fibers and recycled fibers are often used to make newsprint.

Newsprint is generally resistant to being dissolved by water. Instead, newspapers can be soaked in water and used to make paper pulp which can be used to make the biodegradable mulch material of the present invention as described further below. In contrast, other papers made from wood pulp or cotton fibers that are coated with certain chemicals can quickly dissolve in water; and are not suitable for use in the present invention.

Such chemically-coated water-soluble papers are held together by hydrogen bonds between the fibers. When the papers get wet with water, the bonds break down causing the fibers to separate more easily. For example, Aquasol® Water Soluble paper is made of sodium carboxymethyl cellulose and wood pulp and it will dissolve in water. SmartSolve® also makes paper from a cellulose-based material that will dissolve in water. The paper contains fibers that separate when exposed to the water.

As discussed above, newsprint is preferably used in the present invention, and it is generally biodegradable. The newsprint has other advantageous benefits. For example, newsprint is highly available from various sources at relatively low cost, and it has generally good mechanical strength. Also, the newsprint will generally not dissolve in water, and this water insolubility is important for reasons discussed further below. Black inks, which are commonly used to print newspapers, are often soy-based inks and biodegradable. Colored inks often use vegetable-based oils, but newspapers printed with such inks can still be used in accordance with the invention. Newsprint or printed newspapers can be used in accordance with this invention. It is also recognized that brown paper bags could be used in addition to or in place of the newsprint or printed newspapers.

In one preferred embodiment, the method for manufacturing the biodegradable mulch comprises the following steps:
a) soaking newspaper in relatively warm or hot water bath. The newspaper should be immersed in the water, and the temperature of the water is preferably in the range of about 110° F. to about 130° F. Since the water at this temperature range is relatively hot, it will soften the paper quickly. Optionally, the newspaper can be shredded or cut-up into small pieces, and then the small newspaper pieces can be immersed in the water;
b) allowing the newspaper to soak in the water bath for a sufficient period time to soften the paper. In general, the newspaper should soak for a time period of about five (5) to about ten (10) minutes;
c) pounding the newspaper so that it breaks down and forms a paper pulp. It is important the newspaper is broken down sufficiently and the pulp reaches the proper consistency. Any suitable tool can be used for beating the newspaper to form the pulp. For example, a hand-operated drill having a mixing blade can be used to beat the paper so that the resulting pulp has the consistency of oatmeal. In another example, a home blender can be used to beat and blend the newspaper, thus forming paper pulp having a smooth consistency.
d) adding organic matter to the paper pulp. Suitable organic matter includes, for example, organic particulates such as coffee grounds, vegetation such as grass clippings, leaves, hay, straw, bark, woodchips, and compost. Preferably, the organic matter that is added to the pulp is leaves and coffee grounds. If needed, a small amount of water can be added if the viscosity of the paper pulp is too great. The paper pulp can be stored in a sealed bucket or other container if needed. The sealed bucket or other container helps prevent the paper pulp from drying out; and
e) pouring the paper pulp onto a screen and spreading the pulp evenly so that it covers the screen. The pulp may be pressed into the screen so that it has good support. A small amount of water can be added in this step if needed to reduce the pulp viscosity so that the pulp can be spread out uniformly.

In one preferred example, the following composition was used to make a biodegradable mulch mat of approximately five (5) square feet in accordance with the present invention: a) about 20 ounces (oz) of newspaper; b) about 10 ounces (oz) of coffee grounds; and c) about 7.5 ounces (oz) of organic material such as, for example, leaves.

It is understood that the composition of the pulp can vary. For example, in one preferred embodiment, the composition of the pulp is about 40 to about 60 weight % newsprint; about 15 to about 35% weight % coffee grounds; and about 10 to about 30% weight % dried leaves based on weight percent of the composition. In another preferred version, the composition of the pulp is about 50 to about 55 weight % newsprint; about 25 to about 30% weight % coffee grounds; and about 20 to about 25 weight % dried leaves based on weight percent of the composition.

In one preferred embodiment, the total nitrogen content is in the range of about 0.10 to about 1.00 percent based on weight percent of the composition. In another preferred embodiment, the total organic matter is in the range of about 55 to about 95 weight % based on weight of the composition. In yet another preferred embodiment, the total amount of organic carbon is in the amount of 25 to about 95 weight % based on weight of the composition. The carbon to nitrogen ratio for the pulp can vary and in one preferred embodiment is in the range of about 100:1 to about 110:1. In a second preferred embodiment, the carbon to nitrogen ratio for the pulp is in the range of about 50:1 to about 55:1.

As the pulp dries on the screen, it will form a mulch sheet having good mechanical strength and integrity in accordance with the present invention. The mulch sheet will be biodegradable and have good weed-blocking and soil-enhancing properties as described further below. In one embodiment, the mulch sheet is placed “as is” over the vegetable garden, flower garden or other appropriate soil areas. If the soil work site is relatively large, multiple biodegradable mulch sheets can be placed over the area.

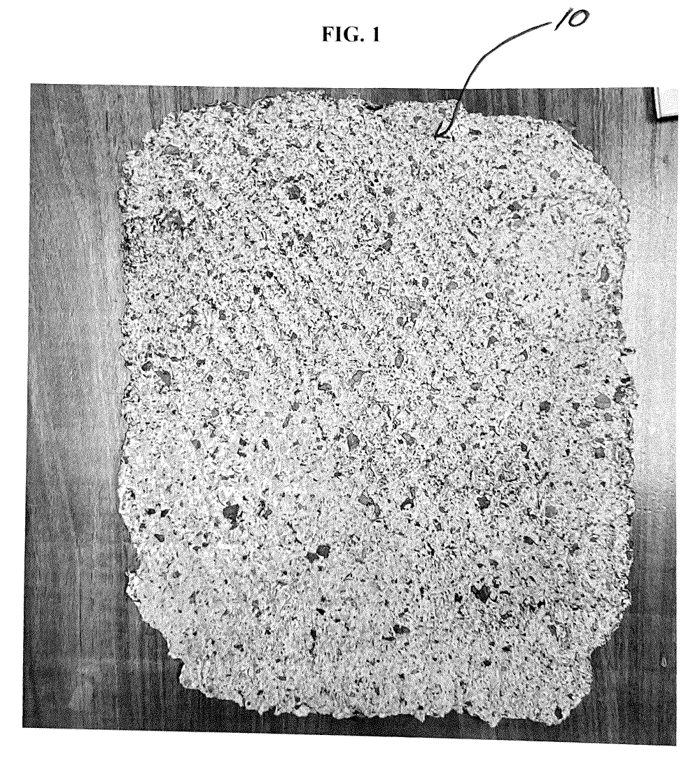

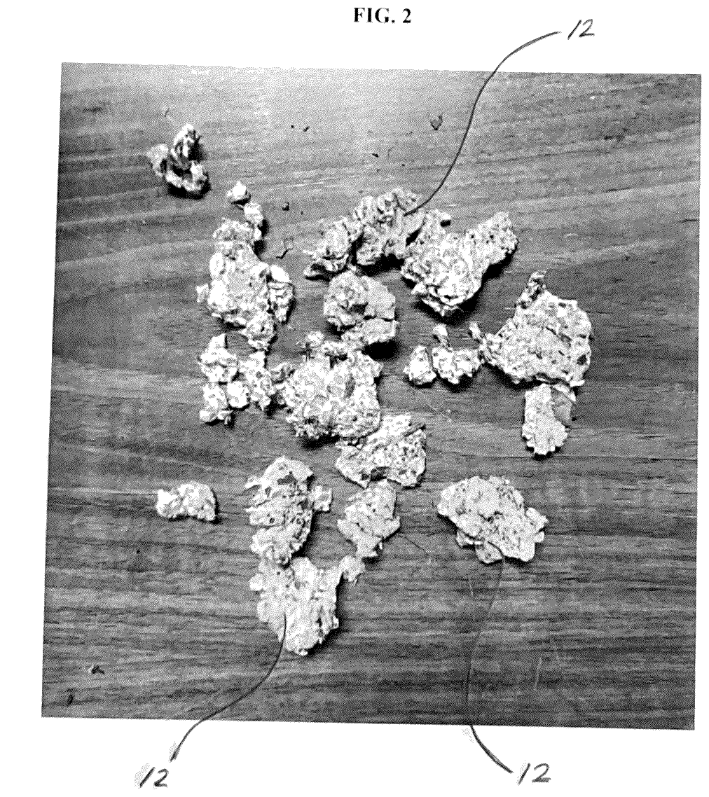

In a preferred embodiment, the biodegradable mulch sheet can be shredded, cut, torn, broken, or the like into smaller mulch pieces if desired. The resulting mulch pieces have smaller dimensions and can be easily spread over the soil area as shown in the following Figures. Referring to FIG. 1, a biodegradable mulch sheet (10) made in accordance with the methods of the present invention is shown. In FIG. 2, another example of biodegradable mulch material (12) is shown. The mulch material shown in FIG. 2, is formed by shredding the mulch sheet (10) shown in FIG. 1.

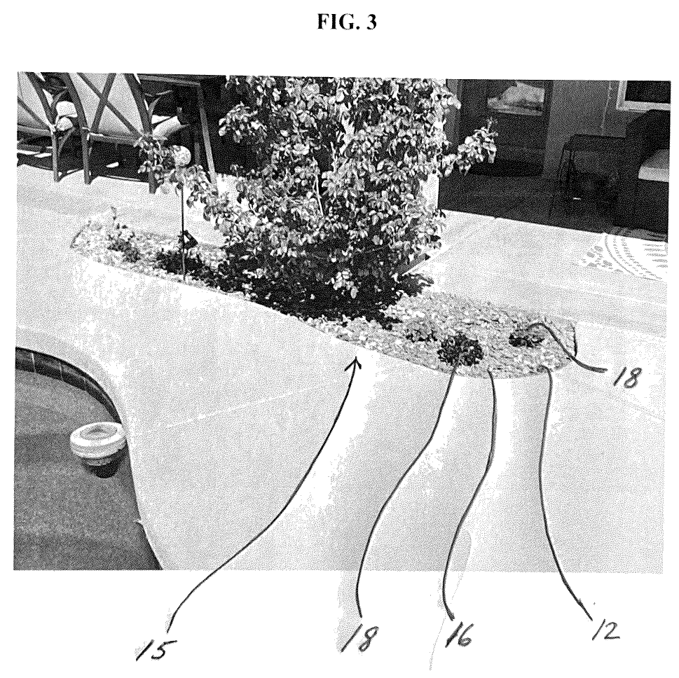

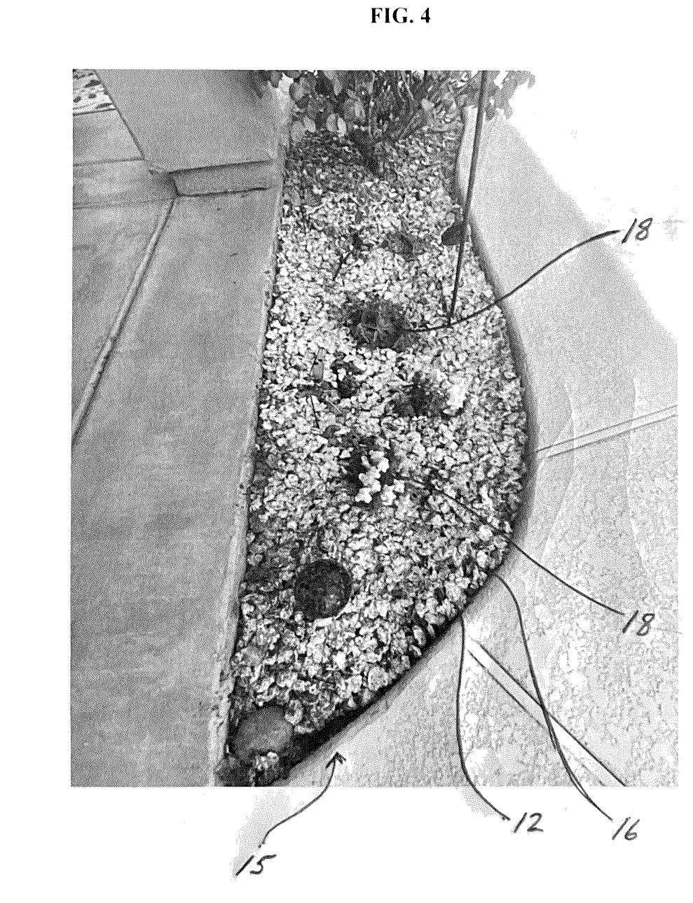

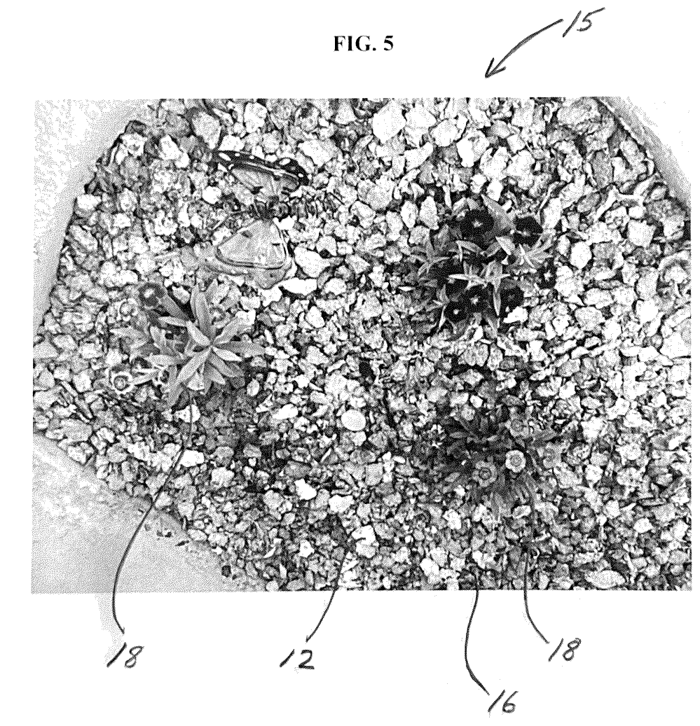

The biodegradable mulch material (12) of the present invention can be spread over different soil areas such as, for example, vegetable gardens and flower gardens. In FIGS. 3, 4, and 5, the biodegradable mulch material (12) is shown spread over different types of garden beds (15) containing shrubbery and flowers. The mulch material (12) controls weed growth and enhances the soil (16) around the flowers (18) in the garden beds. As shown in FIGS. 3, 4, and 5, there is minimal or no growth of weeds after the mulch material (12) has been applied.

The present invention is further illustrated by the following Examples, but these Examples should not be construed as limiting the scope of the invention.

### EXAMPLES

In Example 1, a biodegradable mulch material was prepared in accordance with the following steps of the present invention.

A pile of newspaper was soaked in a relatively hot water bath. The newspaper was immersed in the water, and the temperature of the water was in the range of about 110° F. to about 130° F. Since the water at this temperature range was relatively hot, it softened the paper quickly. The newspaper was soaked in the water bath for a sufficient period time to soften the paper. The newspaper was broken down so that it formed a paper pulp and had the proper consistency. A hand-operated drill having a mixing blade was used to beat the paper so that the resulting pulp has the consistency of oatmeal. Leaves and coffee grounds (organic matter) was added to the paper pulp. The paper pulp was poured onto a screen and the pulp was spread evenly so that it covered the screen. The pulp was dried to form the biodegradable mulch material in the form of a mat; and the mat was removed from the screen.

The biodegradable mulch material was analyzed, and the results are reported in the following Table A.

TABLE A

| Test | Test | | Test |
|---|---|---|---|
| Analysis of | Analysis | Dry Basis | Analysis |
| Sample | Results | Results | Method |
| Moisture Content at | 10.24% | | TMECC 03.09-A |
| 70° C. | | | |
| Solids | 89.76% | | TMECC 03.09-A |
| Total Nitrogen (N) | 0.42% | 0.47% | TMECC 04.02-D |
| Organic Matter | 86.75% | 96.65% | TMECC 05.07 |
| | | | (Calculated) |
| Total Organic Carbon | 43.37% | 48.32% | TMECC 04.01-A |
| (C) | | | |
| Carbon:Nitrogen | 102.8:1 | 102.8:1 | TMECC 05.02-A |
| Ratio (C:N) | | | |

It is understood that the methods for producing biodegradable weed-blocking and soil-enhancing mulch and the mulch material and constructions described and illustrated herein represent only some embodiments of the invention. It is appreciated by those skilled in the art that various changes and additions can be made to methods, materials and structures without departing from the spirit and scope of this invention. For example, it is anticipated that brown paper bags could be used in addition to or in place of the newsprint. It is intended that all such embodiments be covered by the appended claims.

I claim:

1. A method for making biodegradable mulch material, comprising the steps of:
a) soaking newspaper in a relatively warm or hot water bath;
b) allowing the newspaper to soak in the water bath for a sufficient period time to soften the paper;
c) pounding the newspaper so that it breaks down and forms a paper pulp;
d) adding organic matter to the paper pulp; and
e) pouring the paper pulp onto a screen and spreading the pulp evenly so that it covers the screen.

2. The method of claim 1, wherein the water bath has a temperature in the range of about 110° F. to about 130° F.

3. The method of claim 1, wherein the newspaper is allowed to soak in the water bath for a time period in the range of about five (5) to about ten (10) minutes.

4. The method of claim 1, wherein organic particulate and vegetation are added to the paper.

5. The method of claim 4, wherein the organic particulate is coffee grounds.

6. The method of claim 4, wherein the vegetation is selected from the group consisting of grass clippings, leaves, hay, straw, bark, woodchips, and compost.

7. A biodegradable mulch material produced from the method of claim 1.

8. The biodegradable mulch material of claim 1, wherein the total nitrogen content is in the range of about 0.10 to about 1.00 percent.

9. The biodegradable mulch material of claim 1, wherein the total organic matter is in the range of about 55 to about 95 weight percent.

10. The biodegradable mulch material of claim 1, wherein the total amount of organic carbon is in the amount of 25 to about 95 weight percent.
